(19) United States
(12) Patent Application Publication
(10) Pub. No.: US 2025/0097385 A1
(43) Pub. Date: Mar. 20, 2025

(54) MULTIMODAL MEETING SEGMENTATION

(71) Applicant: Zoom Video Communications, Inc., San Jose, CA (US)

(72) Inventors: Bilung Lee, Irvine, CA (US); Vijay Venkataswamy Parthasarathy, San Jose, CA (US); Renjie Tao, Santa Clara, CA (US); Chih-Kai Ting, Milpitas, CA (US); Yun Zhang, Pittsburgh, PA (US)

(73) Assignee: Zoom Video Communications, Inc., San Jose, CA (US)

(21) Appl. No.: 18/778,653

(22) Filed: Jul. 19, 2024

Related U.S. Application Data
(60) Provisional application No. 63/538,627, filed on Sep. 15, 2023.

(51) Int. Cl. H04N 7/15

(52) U.S. Cl. CPC H04N 7/155

(57) ABSTRACT

One method for multimodal meeting segmentation includes receiving a meeting recording and a transcript, the meeting recording comprising a first media stream; generating, using a trained machine learning (“ML”) model, a first set of embeddings corresponding to the first media stream and a second set of embeddings corresponding to the transcript; generating a first set of segments based on the first set of embeddings and a second set of segments based on the second set of embeddings; generating a final set of segments based on the first and second sets of segments; and associating the final set of segments with the meeting recording and storing the final set of segments.

### CROSS-REFERENCE TO RELATED APPLICATIONS

This application claims priority to U.S. Provisional Patent Application No. 63/538,627, filed Sep. 15, 2023, titled “Video Conference Content Segmentation,” the entirety of which is hereby incorporated by reference.

### FIELD

The present application generally relates to videoconferencing, and more particularly relates to segmenting video conference content for further processing such as meeting summary generation

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-2 show example systems for multimodal meeting segmentation;

FIGS. 3A-3B show an example system for multimodal meeting segmentation;

FIGS. 4A-4B show example data flows for multimodal meeting segmentation;

FIGS. 5-6 shows example graphical user interfaces for multimodal meeting segmentation;

FIG. 7 shows an example method for multimodal meeting segmentation; and

FIG. 8 shows an example computing device suitable for use with example systems and methods for multimodal meeting segmentation.

### DETAILED DESCRIPTION

Examples are described herein in the context of multimodal meeting segmentation. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

In modern life, people frequently interact using electronic devices, such as by chat messaging, one-on-one phone calls, or virtual conferences, such as video or telephone conferences. In many cases, such communication channels may be hosted by a virtual conference provider, even in the case of one-on-one phone calls or chat messages. Virtual conference providers may provide enhancements of some of these channels by providing transcripts of a conversation or a conference, either in real-time or after the conclusion of the conference. Real-time transcripts can assist participants who may have difficulty hearing or who do not speak the language(s) used by other participants in the conference. Transcripts can also be used after a conference to review the details of the discussion, which may provide action items or important information to guide work on a project. In some cases, participants may use transcripts of past conferences, chat logs, email chains, or other communications to prepare for an upcoming conference, such as to recall information discussed during the meeting. In other cases, a person may want to obtain a summary of certain aspects of a prior virtual conference or chat discussion, without a summary of the entire conference or discussion.

For example, an individual may have attended a lengthy meeting that covered a variety of topics related to a new product to be released. At a later date, the individual may wish to review some of the discussion in the meeting related to a particular aspect of the product, but not want to review the entire meeting recording or a meeting transcript to find the relevant parts. And while the user can obtain a summary of the entire meeting, they are only interested in certain aspects, making such a fulsome summary excessive. Further, a full summary of the meeting may not provide enough relevant detail for the desired topic.

Thus, to help such a user obtain the targeted information of interest from a larger discussion, they may employ multimodal meeting segmentation to obtain the desired portion of the discussion, which they can then review in its entirety, provide it to an AI assistant to summarize, or otherwise use it as needed. To provide multimodal meeting segmentation, a system accesses stored content from a discussion. For example, in the case of a video conference (or “meeting”), the meeting may be recorded so that audio and video from the meeting are available for use. In addition, the meeting audio may also be transcribed. Thus, the meeting may have several different types of stored information that may be used to segment it in different ways.

To segment the meeting information, each type of information—video, audio, and transcript, in this case—is broken into smaller units for processing. For example, a video may be broken down to the individual frames or small sets of video frames, e.g., one-second's worth of video frames, each of which may be separately processed. Similarly, audio may be broken down into short segments, e.g., 2-5 seconds, while the transcript may be broken down by individual utterance, by sentence, or other unit of speech. The smaller units are then processed by a trained AI model to generate corresponding binary embeddings for each unit that represent the data in the individual units. This results in a set of video frame embeddings, a set of audio embeddings, and a set of transcript embeddings.

The embeddings are then compared to identify groups of related embeddings. For example, if during the video, a particular person speaks for the first ten minutes and occupies a speaker-view within the recorded video, the video embeddings corresponding to the first ten minutes of video will be compared and grouped based on the same person's face being prominently visible. For the next ten minutes, a presentation slide may be displayed. The embeddings corresponding to this ten minutes will be determined to be different from the first set of embeddings for the speaker's face, but similar to each other. Similarly, audio embeddings may be compared to identify speakers or other audio sources and group the embeddings accordingly. A similar process will then be used to identify semantic topics within the transcript and to group the embeddings by topic.

These different sets of embeddings effectively segment the meeting by visual features (e.g., faces or presented content), audio features (e.g., different speakers), or semantic features (e.g., different topics). These different segments can then be used to identify transition times within the meeting between the segments of each type of content. However, because some meetings may dwell on a particular topic or have a particular speaker speaking for an extended period of time, e.g., in a classroom lecture, in some cases, it may be desirable to further divide especially long segments into more manageable sizes. For example, a lecture may have a 3-5 minute topical segment that reviews the prior lecture, a 90-minute topical segment covering the topic for the current lecture, and then a brief 3-5 minute topical segment covering reading assignments for the next lecture. Further, a single audio segment may span the entire recording due to the fact that the professor was the only speaker. Similarly, the video segment may also span the entire recording because the professor was on-screen for the entire lecture.

These long segments may not be desirable for someone attempting to quickly review the meeting or seeking use generative AI to provide a summary of a portion of the meeting. Moreover, some AI systems limit the size of inputs, making it infeasible to provide very long segments for analysis. Thus, the AI assistant may then break down the longer segments into smaller segments based on a predetermined time division, e.g., ten minutes, or a higher threshold for similarity between segments than was initially used. These smaller segments may then be iteratively broken down as needed to achieve a desired maximum segment size. Further, if extremely short segments were created during the process, e.g., segments of 15-30 segments, they may be re-combined with another adjacent segment to provide segments of a useful minimum size. The new set of segments may then be output and used by a user to quickly hone in on topics or interest or to use AI functionality to provide summaries or other information based on the determined segments of the original meeting.

Using such a technique, a user may be able to more easily access and absorb information from lengthy recorded content. The content is broken down according to meaningful metrics and can then be separately processed or consumed as needed in individual segments rather than needing to review the meeting as a whole. Further, by segmenting a meeting using such techniques, more meaningful summary information may be generated. A brief summary of a 90-minute meeting will almost certainly leave out certain information that may be of interest because it is difficult to condense a long discussion into only a few sentences. However, by segmenting the meeting and summarizing the segments, more targeted or meaningful summaries may be provided to the user.

This illustrative example is given to introduce the reader to the general subject matter discussed herein and the disclosure is not limited to this example. The following sections describe various additional non-limiting examples and examples of multimodal meeting segmentation.

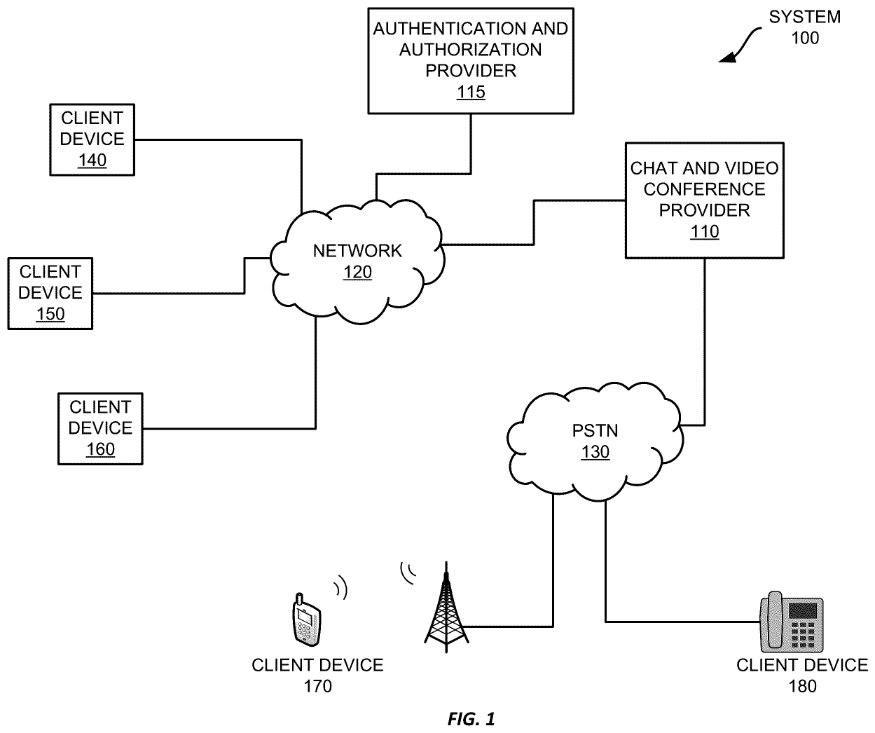

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

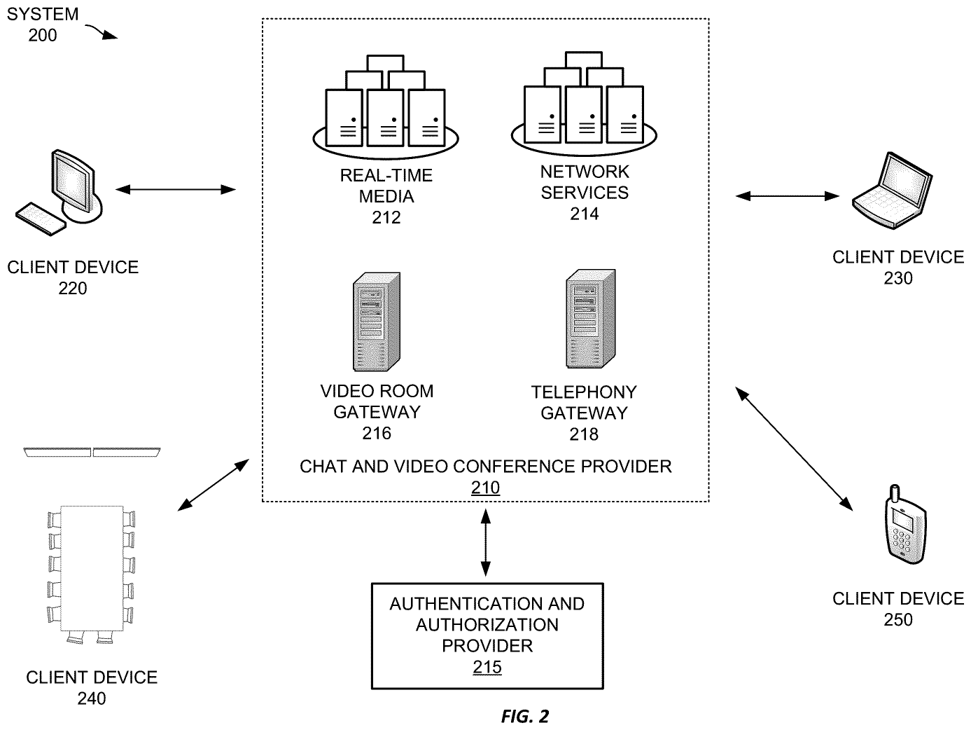

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices, etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

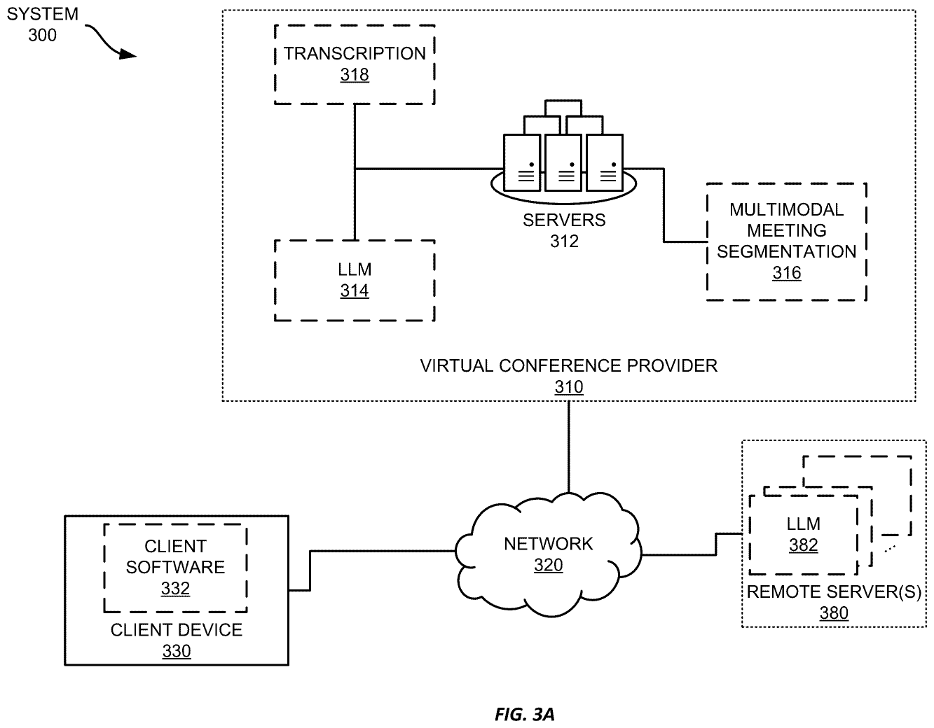

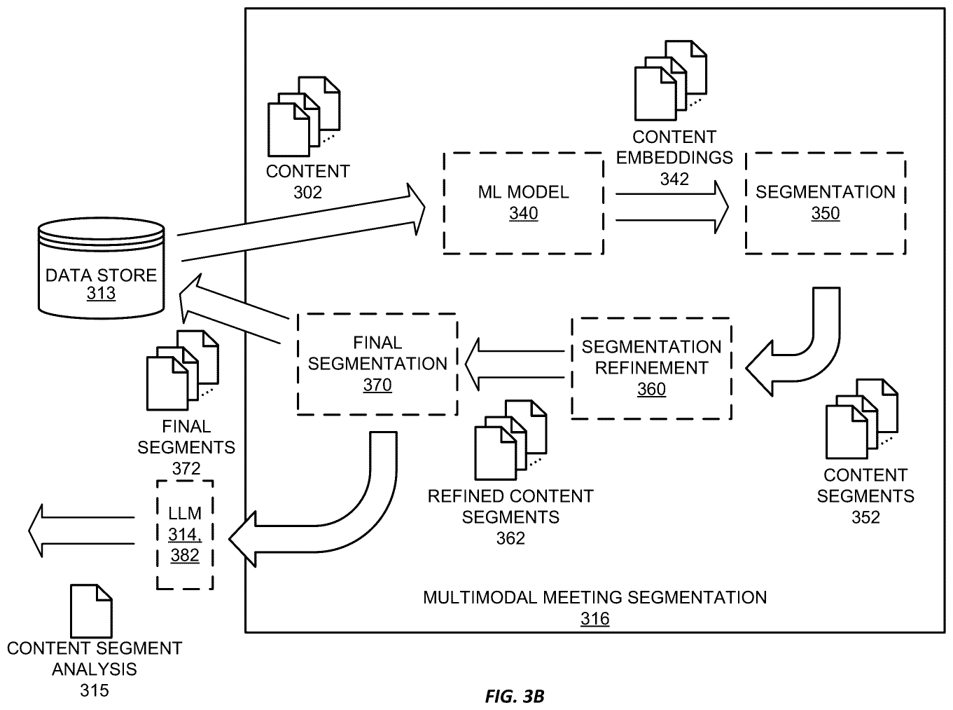

Referring now to FIG. 3A, FIG. 3A shows an example system 300 for multimodal meeting segmentation. In this example, the system 300 includes a client device 330, a virtual conference provider 310, and one or more remote servers 380 that host one or more LLMs 382. In this example, the virtual conference provider 310 provides virtual conferencing capabilities, such as discussed above with respect to FIGS. 1-2, but also provides one or more servers 312 that provide one or more LLMs 314 that may be used to service requests received from users via their respective client device, such as client device 330. In addition, the virtual conference provider provides transcription functionality 318 that employs automatic speech recognition (“ASR”) to generate transcripts of recorded audio and multimodal meeting segmentation functionality 316 (or “meeting segmentation functionality 316”) that can segment content as will be discussed in more detail below.

The LLM 314 may be a model that has been trained on a large corpus of data, such as information available from licensed, commercially usable, non-public datasets. For LLMs, the training data may be written materials, such as webpages, documents, emails, or blogs that may be relevant to generating written works.

In this example the transcription functionality 318 employs a trained ML model, such as a transformer model with an attention mechanism or a neural network (e.g., a recurrent neural network or a convolutional neural network), to provide ASR. However, any suitable non-ML ASR techniques may be employed in some examples.

Client devices may execute client software 332 to join and participate in virtual conferences hosted by the virtual conference provider 310. During a virtual conference, the participants can exchange audio and video streams, as discussed above with respect to FIGS. 1-2, to interact with each other, discuss any topics of interest, and share content. In many cases, participants may wish to record the meeting for later use. After selecting a recording option, the virtual conference provider 310 or a client device 330 records the audio and video streams exchanged during the meeting. After the meeting has concluded (or during the meeting in some cases), the virtual conference provider 310 can employ the transcription functionality 318 to generate a transcript of the audio from the meeting.

Once the transcript has been generated, the meeting recording and the transcript can be provided to the meeting segmentation functionality 316 to generate multimodal segments of the meeting audio, video, and transcript. And while this example relates specifically to recorded video conferences, the meeting segmentation functionality 316 can generate segments for any type of inputted content. For example, chat messaging from a chat channel may be provided, which the meeting segmentation functionality 316 may segment based on different criteria, e.g., topics and individual users. Similarly recorded audio-only meetings may be segmented similarly to a video conference, though without video data.

The generated segments may then be made available to a user at a client device 330 via the client software 332. The user may interact with the client software to view different segments of the meeting or to provide one or more such segments to an LLM 314, 382 to process, such as to generate a summary, to identify one or more action items, or to identify topics for follow-up discussion at a future meeting.

Referring now to FIG. 3B, FIG. 3B shows the multimodal meeting segmentation functionality 316 (or “meeting segmentation functionality 316”) shown in FIG. 3A. The meeting segmentation functionality 316 receives content 302 from a datastore 313 in which various types of content are stored. For purposes of the description of FIG. 3B, the content will be a video conference recording and an associated transcript; however, any sort of content may be stored within the datastore and segmented by the meeting segmentation functionality 316. For example, chat logs, which may be segmented according to user or topic, or phone call recordings, which may be transcribed and segmented according to speaker or topic, may be stored in the data store 313 and provided as content 302 to the meeting segmentation functionality 316.

In this example, the meeting segmentation functionality 316 includes an ML model 340 that receives content and generates corresponding content embeddings 342 for the content. In this example, the meeting segmentation functionality 316 employs a trained ML model 340, such as a trained autoencoder, a trained predictor model, or any other variety of trained neural network, to generate binary embeddings for the content 302. In the case of a video conference recording, the ML model 340 may generate video embeddings, audio embeddings, and transcript embeddings. In this example, the received content is broken into smaller units, each of which has a corresponding embedding generated by the ML model 340. For example, the ML model 340 may generate an embedding for each video frame in a video conference recording. In some examples, short portions (e.g., a second to a few seconds) of the video may be used instead. Similarly, for audio data, it may be divided into short portions (e.g., a second to a few seconds) that are then used to generate corresponding embeddings. For text content, such as a transcript or a chat log, the content may be divided by utterance, sentence, chat message, or other subdivision of the text. The ML model 340 may then generate an embedding for each such subdivision of the text. Thus, for a video conference recording, the generated content embeddings may include video, audio, and transcript embeddings. For chat logs, per-user and topic embeddings may be generated, and for phone call recordings, audio and transcript embeddings may be generated.

The meeting segmentation functionality 316 provides the generated content embeddings to the segmentation functionality 350 to generate content segments 352. To generate the content segments 352, the segmentation functionality 350 groups similar consecutive content embeddings together. In this example, each content embedding comprises a vector of values and the segmentation functionality 350 determines the relative similarity between two embeddings, such as based on a Euclidean distance, cosine, dot product, or any other suitable comparison. A predetermined threshold may be used to determine whether two embeddings are sufficient similar to be grouped together within the same segment. As a result of this process, the segmentation functionality 350 may group video embeddings into segments that represent different dominant visual features, such as a person's face, or presentation content (e.g., a slide). Thus, video segments may be consecutive portions of the video that essentially include the same visual features, e.g., the same speaker or the same slide. Over the course of the meeting as different people speak or different content is shown, a corresponding segment may be generated.

In some cases, the segmentation functionality 350 may determine grouping of embeddings that include apparently unrelated embeddings, such as in the case of one speaker being visible over a duration, while a second speaker appears briefly during that period. The segmentation functionality 350 thus may wait for some threshold number of embeddings before determining that a new segment should be generated. However, after that number of embeddings has elapsed and a difference between the embeddings and the embeddings of the prior segment remains, all embeddings analyzed during that transition period may be grouped in the new segment or some portion of them may be grouped in the new segment. Thus, The segmentation functionality 350 may avoid generating large numbers of very short segments when certain visual, audible, textual, or other content shifts only transiently.

The segmentation functionality 350 independently generates content segments for each different type of content received. For example, in the case of a video conference, the content 302 may include audio, video, and text (e.g., a transcript or a corresponding chat log from the meeting), each of which may be separately segmented.

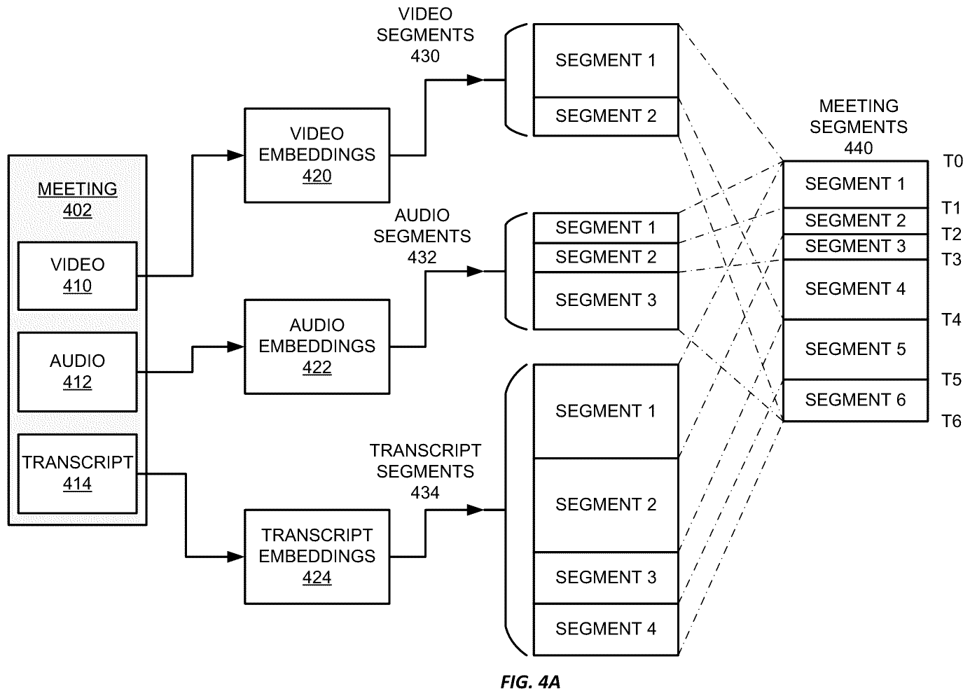

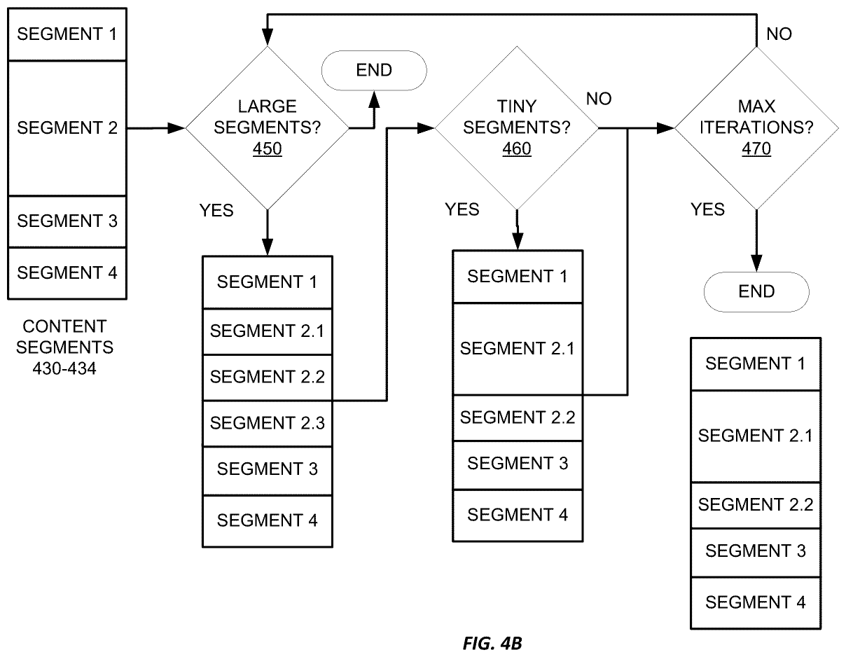

Referring now to FIG. 4A, FIG. 4A illustrates the segmentation of the different portions of content from a recorded video conference. As can be seen, a meeting recording 402 that includes video 410, audio, 412, and a transcript 414 is provided as content 302 to the ML model 340 to generate corresponding video, audio, and transcript embeddings 420-424. The embeddings 420-424 are provided to the segmentation functionality 350, which generates video, audio, and transcript segments 430-434 based on the embeddings. The segments 430-434 are then used to generate final segments 440 for the original meeting recording as will be discussed in more detail below.

Returning to FIG. 3, after the content segments 352 are generated, they may be immediately provided to the final segmentation 370 to generate segments for the video conference (or chat log or phone call recording) without employing the segmentation refinement functionality 360. However, in some cases, segmentation refinement functionality 360 is employed when one or more of the content segments exceeds a threshold duration. For example, if one of the video segment lasts for twenty minutes, the video content segments may be provided to the segmentation refinement functionality for refinement 360.

To refine the content segments 352, the segmentation refinement functionality 360 in this example, performs the flow illustrated in FIG. 4B. In FIG. 4B, a set of content segments 352, e.g., video, audio, or transcript segments 430-434, are analyzed to determine whether any content segments in the set of content segments satisfy a threshold 450, such as a length or duration threshold. In this example, the threshold is established as ten minutes; however, any suitable threshold may be employed. For example, for video or audio, a predetermined number of seconds or minutes may be used. For text, a predetermined number of words may be used. For each content segment that satisfies the threshold, the segmentation refinement functionality 360 partitions those segments into smaller segments. As can be seen in FIG. 4B, content segment 2 is partitioned into segments 2.1-2.3. In this example, the segmentation refinement functionality 360 determines the similarities between embeddings associated with the content segments and establishes a more restrictive threshold than was used by the segmentation functionality 350. Thus, segment transitions may become more likely. In some examples, however, partitioning may be performed by dividing the content segment into an equal number of segments, such as three or four.

After the segmentation refinement functionality 360 has partitioned large segments, it then determines whether any smaller segments are satisfy a second threshold 460, such as length or duration threshold. For any segments that satisfy the second threshold, they are re-combined with a preceding or succeeding segment. Because using a more restrictive threshold may make segment transitions more likely, some very short segments may be generated, e.g., 10-15 second segments or 20-30 words. For any segments that are too short or small, e.g., based on a predetermined threshold, they may be re-combined with a preceding or succeeding partitioned segment. For example, the segmentation refinement functionality 360 may determine a similarity between the tiny segment and the preceding and succeeding segments. It may then combine the tiny segment with the most similar of the preceding and succeeding segments. Thus, the tiny segments are all eliminated by combining them with another segment. In some examples, multiple tiny segments may be combined together to form a larger segment.

Once all of the tiny segments have been processed, if a maximum number of iterations has not been satisfied The process then repeats for the modified segments 470 until a maximum number of iterations has been performed, e.g., a maximum of three iterations. If not, the process returns to block 450 to determine if any large segments 450 still remain. If so, the process proceeds as before. If not, however, the process terminates and the set of modified segments are output as the set of refined content segments 362.

Referring again to FIG. 3, the set of refined content segments 362 are generated and applied to a timeline for the video conference based on the lengths of the various segments and a correspondence to the original video conference recording. For example, each refined video segment is stored as a timestamp corresponding to the video conference recording. Similarly, each refined audio segment is also stored as a timestamp corresponding to the video conference recording. Further, the transcript segments are similarly aligned to the video conference recordings, e.g., based on timestamps within the transcript, and the timestamps for the transcript segments are also stored. Thus, the video conference recording is stored with corresponding video, audio, and transcript segment timestamps. A user who wishes to review a particular portion of the video conference may then select a video, audio, or transcript segment and the virtual conference provider 310 can access the datastore 313 to obtain the video conference recording and the corresponding timestamps for the selected portion of the video conference recording.

Referring again to FIG. 4A, the meeting segments 440 are represented by timestamps T0-T6, which are generated based on the various video, audio, and transcript segments 430-434 as illustrated in the Figure. For example, meeting segment 1 begins at the beginning of the video (T0). T1 is established by the end of the first segment 430-434. In this case, audio segment 1 concludes at T1 before either of video segment 1 or transcript segment 1. Thus, T1 is added as the first time stamp and the time stamp is assigned metadata indicating that it corresponds to the end of audio segment 1. Meeting segment 2 then begins at T1 and ends at T2, which corresponds to the end of transcript segment 1, which ends before audio segment 2 and video segment 1, and T2 is created with metadata indicating that it corresponds to the end of transcript segment 1. This process continues until all video, audio, and transcript segments 430-434 are represented by time stamps and corresponding metadata. Because of this approach, a single content segment may span multiple meeting segments 440, but the video, audio, and transcript segments 430-434 may each have different overlapping durations. Thus, a user may access the video conference recording according to any of the different types of segments represented in the video conference.

Referring again to FIG. 3B, FIG. 3B generates the final segments 372 for the video conference, generally as discussed above with respect to FIG. 4A. The final segments 372, such as the meeting segments 440 shown in FIG. 4A, may then be stored as metadata corresponding to the video conference recording and transcript in the datastore 313. In some examples, a user may select an option in a GUI to obtain a summary or other analysis of a particular segment of the meeting, e.g., based on a video, audio, or transcript segment. The corresponding final segments 372 of the video conference recording may then be provided to an LLM 314, 382 to generate a summary of that portion of the video conference. For example, if a user selects an option to summarize video segment 2 (shown in FIG. 4), the meeting segments 440 spanning T4-T6 will be provided to the LLM 314, 382 to summarize. In this example, the meeting segmentation functionality provides the portions of the transcript corresponding to the selected segments to summarize, such as based on time stamps T4 and T6 and timestamps contained within the original transcript of the video conference.

It should be appreciated that while the discussion above was generally directed to video conference recordings having audio, video, and transcripts, the techniques are applicable to other types of recordings, such as recordings of audio conferences that have a corresponding transcript, or other types of communications, such as chat logs. Still other types of multimodal data may be used according to different examples.

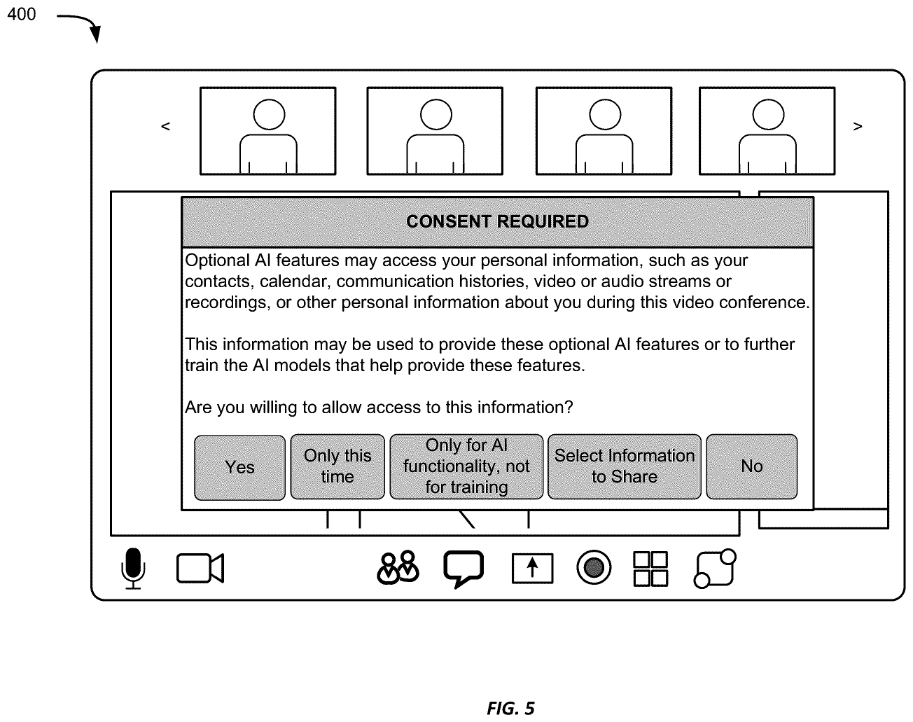

Referring now to FIG. 5, FIG. 5 shows a GUI 500 presenting a consent option to employ certain AI-assisted features. In some examples according to the present disclosure, a user may select an option to use one or more optional AI features available from the virtual conference provider, such as segmentation or summarization functionality or to train that segmentation or summarization functionality as described herein. The use of these optional AI features may involve providing the user's personal information to the AI models underlying the AI features. The personal information may include the user's contacts, calendar, communication histories, video or audio streams, recordings of the video or audio streams, transcripts of audio or video conferences, or any other personal information available to the virtual conference provider. Further, the audio or video feeds may include the user's speech, which includes the user's speaking patterns, cadence, diction, timbre, and pitch; the user's appearance and likeness, which may include facial movements, eye movements, arm or hand movements, and body movements, all of which may be employed to provide the optional AI features or to train the underlying AI models.

Before capturing and using any such information, whether to provide optional AI features or to providing training data for the underlying AI models, the user may be provided with an option to consent, or deny consent, to access and use some or all of the user's personal information. In general, Zoom's goal is to invest in AI-driven innovation that enhances user experience and productivity while prioritizing trust, safety, and privacy. Without the user's explicit, informed consent, the user's personal information will not be used with any AI functionality or as training data for any AI model. Additionally, these optional AI features are turned off by default-account owners and administrators control whether to enable these AI features for their accounts, and if enabled, individual users may determine whether to provide consent to use their personal information.

As can be seen in FIG. 5, a user has engaged in a video conference and has selected an option to use an available optional AI feature. In response, the GUI has displayed a consent authorization window for the user to interact with. The consent authorization window informs the user that their request may involve the optional AI feature accessing multiple different types of information, which may be personal to the user. The user can then decide whether to grant permission or not to the optional AI feature generally, or only in a limited capacity. For example, the user may select an option to only allow the AI functionality to use the personal information to provide the AI functionality, but not for training of the underlying AI models. In addition, the user is presented with the option to select which types of information may be shared and for what purpose, such as to provide the AI functionality or to allow use for training underlying AI models.

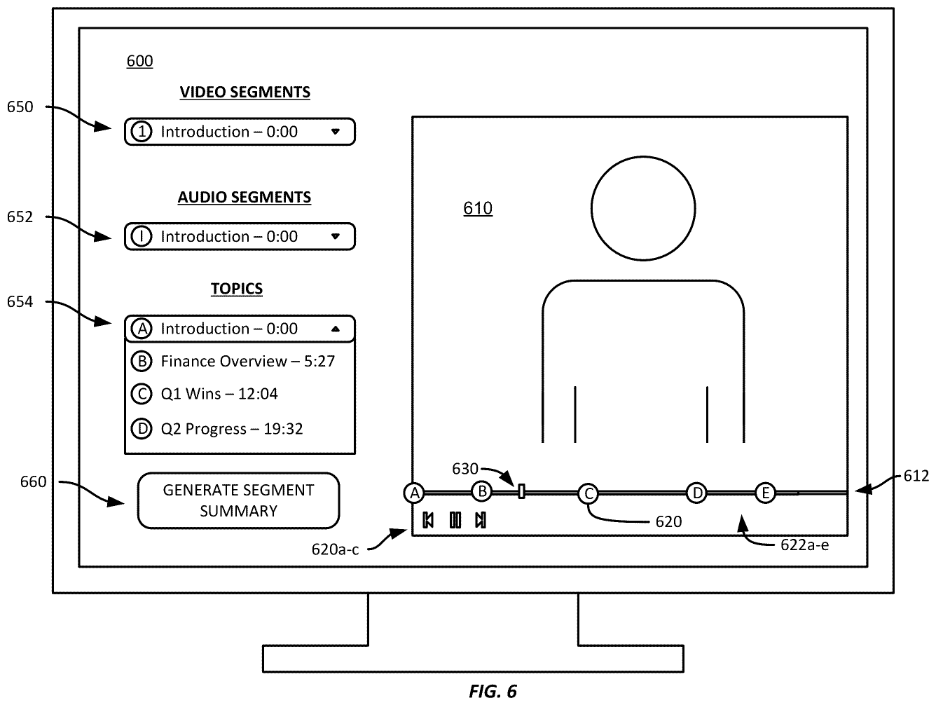

Referring now to FIG. 6, FIG. 6 shows an example graphical user interface (“GUI”) 600 according to an example system for multimodal meeting segmentation. This example GUI 600 will be discussed with respect to the example system 300 shown in FIGS. 3A-3B, but it should be appreciated that any suitable system according to this disclosure may be employed.

The GUI 600 shown in FIG. 6 is provided by the client software 332 executed by the client device 330; however, in some examples, the GUI 600 may be provided as a web portal by a remote computing device, such as by a server hosted by the virtual conference provider 310 or by a remote server 382. This example GUI 600 is displayed on a display screen and provides an interface for a user to interact with a video conference recording or other recorded content, such as an audio recording. The GUI 600 includes a video window 610 that includes playback controls 620a-c to play/pause 620b the video recording, and segment skip forward/reverse buttons 620a, c. The video timeline 612 is shown with a cursor 614 showing the current frame of the video recording in the timeline 612, which can be used to scrub through the video. In addition, five markers 622a-e are positioned on the timeline 612 at locations corresponding to different timestamps within the video. The markers may be used to quickly jump to a particular segment of the video recording. Further, the skip forward/reverse buttons 616a,c may be used to jump between successive markers, which correspond to different segments of the video.

In addition, the GUI 600 provides options to select particular segments within the video recording. Since the GUI 600 is showing a video conference recording, the GUI 600 presents options to select video segments, audio segments, and topical segments using a corresponding drop-down menu 650-654. In this example, the user has opened the topical segment drop-down menu 654 and is provided with a listing of the different topic segments within the video recording. Each menu identifies its corresponding segments using a different numbering scheme: the video segments use numbers, the audio segments use Roman numerals, and the topical segments use letters. In this example, because the user has selected the topical segment menu 654, the corresponding markers 622a-e are overlaid on the video timeline 612 as well. The user may then select one of the available segments to cause the GUI 600 to jump to the beginning of the segment, which will allow the user to begin playback of the selected segment. Alternatively, the user could select a segment using one of the markers 622a-e on the timeline 612. And while the topical segments are used in this example, the user may select any of the menus to select from any of the available segments, which will also cause the markers 622a-e on the timeline 613 to switch to correspond to those within the menu the user has selected. Thus, the user may interact with the video recording to review exactly those portions of the video recording that are of interest.

In addition to reviewing particular segments of the video recording, the GUI 600 also provides a control 660 to generate a summary of a selected segment. For example, the user may select one of the video, audio, or topical segments of the video recording and select the control 600. In response, the client application 332 transmits a request to for a summary of the selected segment. In this example, the request identifies the segment, while in some cases, the request may identify the beginning and end of the segment within the recording. The request may be transmitted to the virtual conference provider 310, which can access the corresponding transcript and excerpt the portion of the transcript corresponding to the identified segment. The excerpted portion of the transcript may then be provided to an LLM 314, 382 along with a prompt to generate a summary of the excerpted portion of the transcript. The video conference provider 310 receives the summary from the LLM 314, 382 and provides it to the user to view within the GUI 600 or saves it to a file. In some examples, however, the client application 332 itself may excerpt the portion of the transcript corresponding to the selected segment and transmit a request to an LLM 314, 382 to generate a summary of the excerpted portion of the transcript. After receiving the summary from the LLM 314, 382, the client software 332 can provide the summary via the GUI 600 or save it to a file for later review.

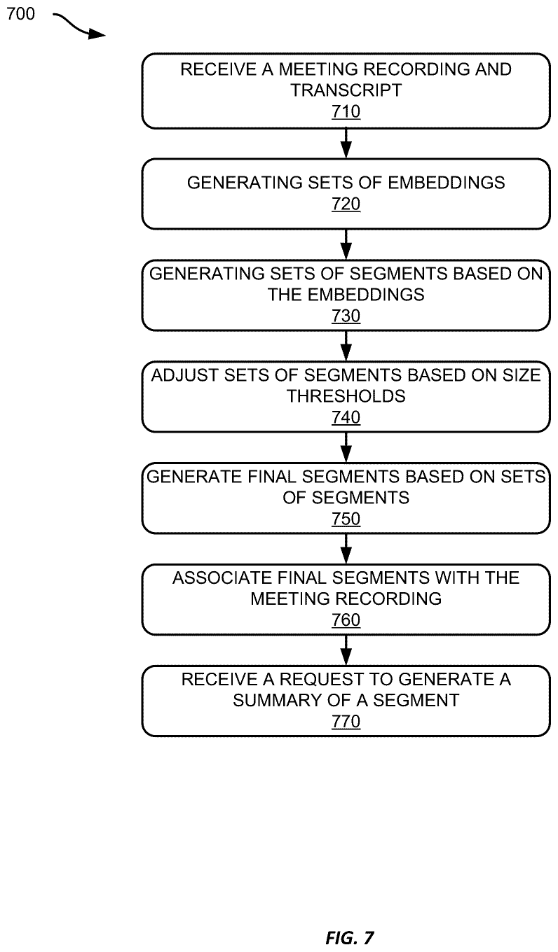

Referring now to FIG. 7, FIG. 7 shows an example method 700 for multimodal meeting segmentation. The method 700 will be discussed with respect to the example system shown in FIGS. 3A-3B and 4A-4B as well as the GUI 600 shown in FIG. 6; however, it should be appreciated that any suitable system or GUI according to this disclosure may be employed. Further, while this description is with respect to a virtual conference provider 310, any suitable service provider may be employed.

At block 710, the meeting segmentation functionality 316 receives a meeting recording and a transcript, the meeting recording including a first media stream, generally as discussed above with respect to FIG. 3B. In this example, the meeting segmentation functionality 316 receives a video conference recording that includes a video stream and an audio stream. Because multiple people attended the video conference, the various videos and audio streams exchanged between the people in the meeting have been recorded as a single video stream and a signal audio stream within the recording. However, in some examples, one or more individual video or audio streams may be separate recorded as an individual video or audio stream within the recording. For example, a recording of a video conference with four participants may separately record video and audio streams for each participant, resulting in the recording having four video streams and four audio streams. In addition, as discussed above, other types of recordings may be employed, including recordings of audio conferences and corresponding transcript. In this example, the transcript was generated by the virtual conference provider 310 using suitable ASR functionality and has associated the transcript with the video conference recording.

At block 720, the meeting segmentation functionality 316 generates a set of embeddings for each stream within the meeting recording as well as a set of embeddings for the transcript, generally as described above with respect to FIG. 3B. In this example, the ML model 340 generates a set of content embeddings for the video stream, a set of content embeddings for the audio stream, and a set of content embeddings for the transcript. However, for other meeting recording different sets of embeddings may be generated. For example, for an audio meeting recording and transcript, the ML model 304 generates a set of content embeddings 742 for the audio stream and a set of content embeddings 742 for the transcript.

At block 730, the meeting segmentation functionality 316 generates a set of segments for each set of content embeddings 742, generally as discussed above with respect to FIGS. 3B and 4A-B. In this example, the content segmentation functionality 350 generates a set of segments based on the video embeddings, a set of segments based on the audio embeddings, and a set of segments based on the transcript embeddings. As discussed above with respect to FIG. 3B, the segmentation functionality 350 evaluates the similarity between consecutive embeddings, such as by using a Euclidean distance, a cosine similarity, or a dot product similarity, and groups related embeddings into different segments. Further, as discussed above, if first and second consecutive embeddings are apparently dissimilar, the content segmentation functionality 350 may wait for a threshold number of embeddings being dissimilar from the first embedding before determining that a new segment has begun. Still other techniques may be employed to determine groups of embeddings into segments.

At block 740, the content segments 352 generated by the content segmentation functionality 350 may be provided to segmentation refinement functionality 360 to help ensure that no segments are too long or too short, as discussed above with respect to FIGS. 3B and 4B, though this block 740 is optional and may not be performed in some examples. In this example, for each set of segments, the segmentation refinement functionality 360 determines any segments within the set that satisfy a length threshold. For any that do, it partitions the segment into a set of partitioned segments, such as by identifying the corresponding embeddings to the segmentation functionality 350 and indicating it should use a higher similarity threshold. This may result in the segmentation functionality 350 generating shorter segments by requiring a greater degree of similarity between embeddings, or by shorting a window before determining that a new segment has begun. The resulting partitioned segments are then provided to the segmentation refinement functionality 360. In some examples, the segmentation refinement functionality 360 may instead evenly partition the segment into a set of partitioned segments.

After partitioning a long segment, the segmentation refinement functionality 360 may determine whether any of the partitioned segments is too short by comparing each to a second threshold. For any that are too short, it may merge them with a preceding or succeeding segment, whether another partitioned segment or another segment in the set of segments being processed by the segmentation refinement functionality 360. The segmentation refinement functionality 360 may then determine whether a maximum number of iterations has been reached. If so, it outputs the refined content segments 362. Otherwise, it determines whether any more segments within the set of content segments 352 are too long. And while this example employs a limit on the number of iterations, some examples may not.

At block 750, the meeting segmentation functionality 316 generates a final set of segments for the meeting recording, generally as described above with respect to FIGS. 3B and 4A-4B. In this example, the meeting segmentation functionality 316 employs final segmentation functionality 370 to generate final segments by establishing timestamps corresponding to the meeting recording based on the beginning and ending of each segment in each set of refined content segments 362 (or each set of content segments 352, if segmentation refinement is not used).

At block 760, the meeting segmentation functionality 316 associates and stores the final meeting segments 372 with the meeting recording in the datastore 313, generally as described above with respect to FIG. 3B.

At block 770, a user, using their client application, transmits a request for a summary of a segment of a meeting recording. In response, the virtual conference provider 310 accesses the transcript corresponding to the meeting recording and determines, such as based on timestamps within the transcript, a corresponding portion of the transcript for the identified segment. The virtual conference provider 310 then excerpts the corresponding portion of the transcript and provides it to an LLM 314, 382 along with a prompt to generate a summary of the excerpted portion of the transcript. The virtual conference provider 310 may then receive the summary from the LLM 314, 382 and provide it to the user's client application 332.

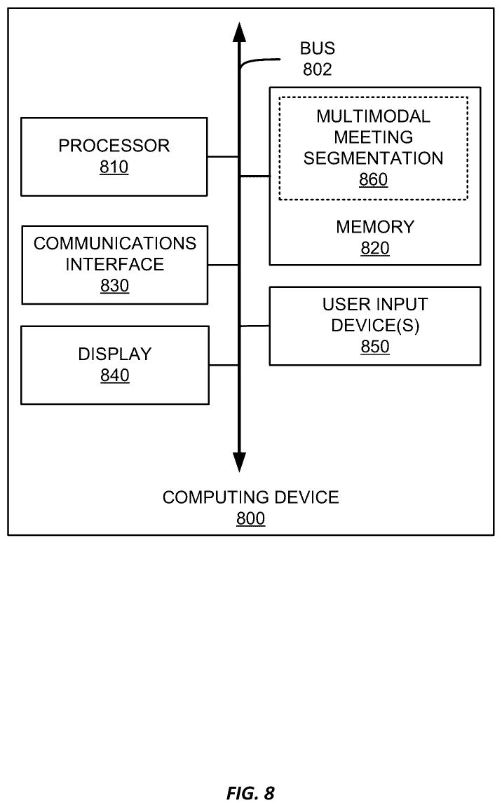

Referring now to FIG. 8, FIG. 8 shows an example computing device 800 suitable for use in example systems or methods for multimodal meeting segmentation according to this disclosure. The example computing device 800 includes a processor 810 which is in communication with the memory 820 and other components of the computing device 800 using one or more communications buses 802. The processor 810 is configured to execute processor-executable instructions stored in the memory 820 to perform one or more methods for multimodal meeting segmentation according to different examples, such as part or all of the example method 700 described above with respect to FIG. 7. Suitable example computing devices 800, such as user client devices, may also include one or more user input devices 850, such as a keyboard, mouse, touchscreen, microphone, etc., to accept user input. The computing device 800 also includes a display 840 to provide visual output to a user. In addition, the computing device 800 includes multimodal meeting segmentation 860, such as discussed above with respect to FIGS. 3A-3B and 4A-4B.

The computing device 800 also includes a communications interface 830. In some examples, the communications interface 830 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
receiving a meeting recording and a transcript, the meeting recording comprising a first media stream;
generating, using a trained machine learning (“ML”) model, a first set of embeddings corresponding to the first media stream and a second set of embeddings corresponding to the transcript;
generating a first set of segments based on the first set of embeddings and a second set of segments based on the second set of embeddings;
generating a final set of segments based on the first and second sets of segments; and
associating the final set of segments with the meeting recording and storing the final set of segments.

2. The method of claim 1, wherein the meeting recording comprises a second media stream, the first media stream comprising an audio stream and the second media stream comprising a video stream, and further comprising:
generating, using the trained ML model, a third set of embeddings corresponding to the second media stream;
generating a third set of segments based on the third set of embeddings; and
wherein generating the final set of segments is further based on the third set of segments.

3. The method of claim 1, wherein:
generating the first set of segments is based on a similarity between consecutive embeddings within the first set of segments; and
generating the second set of segments is based on a similarity between consecutive embeddings within the second set of segments.

4. The method of claim 3, wherein the similarity between consecutive embeddings within the first set of segments and the similarity between consecutive embeddings within the first set of segments is based on at least one of a Euclidean distance, cosine, or dot product between the consecutive embeddings within the respective sets of embeddings.

5. The method of claim 1, wherein generating the first and second sets of segments comprises:
responsive to identifying, in a respective set of segments, a first segment having a length satisfying a first threshold, partitioning the first segment into a plurality of partitioned segments.

6. The method of claim 5, further comprising:
for each partitioned segment, responsive to determining that the respective partitioned segment satisfies a second threshold, merging the respective partitioned segment into a preceding or succeeding segment.

7. The method of claim 6, further comprising iteratively, after the partitioning and merging:
responsive to determining that none of the segments within the respective set of segments satisfies the first threshold, outputting the respective set of segments; and
otherwise performing the partitioning and merging on each segment satisfying the first threshold.

8. The method of claim 7, further comprising, responsive to determining that a maximum number of iterations has been reached, outputting the respective set of segments.

9. A system comprising:
a non-transitory computer-readable medium; and
one or more processors communicatively connected to the non-transitory computer-readable medium, the one or more processors configured to execute processor-executable instructions stored in the non-transitory computer-readable medium to cause the one or more processors to:
receive a meeting recording and a transcript, the meeting recording comprising a first media stream;
generate, using a trained machine learning (“ML”) model, a first set of embeddings corresponding to the first media stream and a second set of embeddings corresponding to the transcript;
generate a first set of segments based on the first set of embeddings and a second set of segments based on the second set of embeddings;
generate a final set of segments based on the first and second sets of segments; and
associate the final set of segments with the meeting recording and storing the final set of segments.

10. The system of claim 9, wherein the meeting recording comprises a second media stream, the first media stream comprising an audio stream and the second media stream comprising a video stream, and wherein the one or more processors are configured to execute further processor-executable instructions stored in the non-transitory computer-readable medium to:
generate, using the trained ML model, a third set of embeddings corresponding to the second media stream;
generate a third set of segments based on the third set of embeddings; and
generate the final set of segments further based on the third set of segments.

11. The system of claim 9, wherein the one or more processors are configured to execute further processor-executable instructions stored in the non-transitory computer-readable medium to:
generate the first set of segments is based on a similarity between consecutive embeddings within the first set of segments; and
generate the second set of segments is based on a similarity between consecutive embeddings within the second set of segments.

12. The system of claim 11, wherein the similarity between consecutive embeddings within the first set of segments and the similarity between consecutive embeddings within the first set of segments is based on at least one of a Euclidean distance, cosine, or dot product between the consecutive embeddings within the respective sets of embeddings.

13. The system of claim 9, wherein the one or more processors are configured to execute further processor-executable instructions stored in the non-transitory computer-readable medium to:
responsive to identifying, in a respective set of segments, a first segment having a length satisfying a first threshold, partition the first segment into a plurality of partitioned segments.

14. The system of claim 13, wherein the one or more processors are configured to execute further processor-executable instructions stored in the non-transitory computer-readable medium to:
for each partitioned segment, responsive to determining that the respective partitioned segment satisfies a second threshold, merge the respective partitioned segment into a preceding or succeeding segment.

15. The system of claim 14, wherein the one or more processors are configured to execute further processor-executable instructions stored in the non-transitory computer-readable medium to iteratively, after the partitioning and merging:
responsive to determining that none of the segments within the respective set of segments satisfies the first threshold, output the respective set of segments; and
otherwise perform the partitioning and merging on each segment satisfying the first threshold.

16. The system of claim 15, wherein the one or more processors are configured to execute further processor-executable instructions stored in the non-transitory computer-readable medium to, responsive to determining that a maximum number of iterations has been reached, output the respective set of segments.

17. A non-transitory computer-readable medium comprising processor-executable instructions configured to cause one or more processors to:
receive a meeting recording and a transcript, the meeting recording comprising a first media stream;
generate, using a trained machine learning (“ML”) model, a first set of embeddings corresponding to the first media stream and a second set of embeddings corresponding to the transcript;
generate a first set of segments based on the first set of embeddings and a second set of segments based on the second set of embeddings;
generate a final set of segments based on the first and second sets of segments; and
associate the final set of segments with the meeting recording and storing the final set of segments.

18. The non-transitory computer-readable medium of claim 17, wherein the meeting recording comprises a second media stream, the first media stream comprising an audio stream and the second media stream comprising a video stream, and further comprising processor-executable instructions configured to cause the one or more processors to:
generate, using the trained ML model, a third set of embeddings corresponding to the second media stream;
generate a third set of segments based on the third set of embeddings; and
generate the final set of segments further based on the third set of segments.

19. The non-transitory computer-readable medium of claim 17, further comprising processor-executable instructions configured to cause the one or more processors to:
generate the first set of segments is based on a similarity between consecutive embeddings within the first set of segments; and
generate the second set of segments is based on a similarity between consecutive embeddings within the second set of segments.

20. The non-transitory computer-readable medium of claim 19, wherein the similarity between consecutive embeddings within the first set of segments and the similarity between consecutive embeddings within the first set of segments is based on at least one of a Euclidean distance, cosine, or dot product between the consecutive embeddings within the respective sets of embeddings.
